(19) United States
(12) Patent Application Publication
(10) Pub. No.: US 2011/0250352 A1
(43) Pub. Date: Oct. 13, 2011

(54) Vehicular clear coat scratch repair composition and method

(75) Inventors: Leo Petetti, Hammonton, NJ (US); Jules Hermele, Westfield, MA (US); Vijay Mathur, Westborough, MA (US)

(73) Assignee: I.P. 3 Group, LLC, Hammonton, NJ (US)

(21) Appl. No.: 12/798,648

(22) Filed: Apr. 8, 2010

(51) Int. Cl. B05D 3/12

(52) U.S. Cl. 427/142

(57) ABSTRACT

A method for repairing a scratch in the clear top coat overlying a pigmented base coat on a metallic substrate, without damaging the pigmented base coat, involves the steps of applying an amount of a repair composition to the scratch at least sufficient to fill the scratch, spreading the composition into and over the scratch until the composition at least fills the scratch, removing excess composition, allowing the composition to air dry, sanding the dried composition to create a smooth, continuous surface at the site of the scratch and buffing the sanded surface with a fine polishing compound to establish a high gloss, clear coat surface at the site of the scratch. A desirable resin composition consists essentially of, in percent by weight of the composition, toluene 10-18%, n-butyl acetate 10-15%, ethyl acetate 0-5%, acetone 20-25%, acrylic resins 30-50%, surface tension reducer 0-0.5% and plasticizer/coalescent 0-3%.

### FIELD OF THE INVENTION

The present invention relates to coating compositions and methods for coating metallic substrates and, more particularly to compositions and methods for repairing scratches in the clear top coat applied over the pigmented base coat or color coat on metallic substrates, particularly on vehicles such as automobiles and trucks.

### BACKGROUND OF THE INVENTION

Colored base coatings and clear top coatings are conventionally applied to the metallic substrates of vehicles, such as automobiles and trucks, to protect the substrates and provide an attractive glossy and distinctively aesthetic finish. A typical vehicle substrate has several coating layers. The substrate is typically first coated with an inorganic rust-proofing layer over which is applied a primer coat. A pigmented base coat or color coat is next applied over the primer. A typical base coat or color coat may contain metallic flakes to provide a metallic-appearing finish. To protect and preserve the aesthetic qualities of the color finish, a clear, transparent, unpigmented top coat is applied over the pigmented base coat to protect the base coat from defects due to contact with objects causing scratching or chipping of the base coated surface and from environmental elements, such as acidic precipitation, exposure to ultraviolet radiation from sunlight, high relative humidity and high temperatures. Clear top coatings are typically baked onto the pigmented base coat.

As a result of the protective characteristics of clear top coats (hereinafter “clear coat” or “top coat”), it is common for the clear coat to be scratched or chipped while protecting the underlying pigmented base coat. Unfortunately, there does not currently exist a satisfactory method for repairing scratches or chips (hereinafter “scratches”) in the clear coat without also involving the underlying pigmented base coat (frequently referred to as the paint coating). Currently, in order to repair a scratch in the clear coat, it is first necessary to sand away the scratch, which invariably sands away a portion of the underlying paint coat. A primer coat is applied to the sanded area to protect the exposed metallic substrate and the sanded paint coat, after which the primer coat is itself sanded to improve adhesion. At the same time, areas adjacent the scratch are also sanded to facilitate color blending when the paint coat is applied. The area to be painted is next taped off from the remainder of the vehicle and any trim, door handles, lens covers, etc. are removed from the area to be painted. In an approved paint facility, the paint or color coat is applied to the taped area and color blended, as needed. Thereafter, the tape is removed and a clear top coat is applied to the newly painted area as well as to adjacent areas of the vehicle panels to which paint was applied. It is not uncommon for repair of scratches in the clear coat to require that entire body panels of automobiles be repainted and/or re-coated with clear coat. After the clear coat has dried, any removed trim, door handles, lens covers, etc. are replaced. It will be appreciated that this procedure is time consuming, requires specialized equipment and, in the end, is a very expensive means for removing scratches in the clear coat.

There are numerous processes and compositions disclosed in the prior art for paint scratch repair and for top coat compositions which exhibit improved scratch resistance. However, heretofore, there have been no known compositions intended specifically for the repair of scratches in vehicular clear coats and no known methods for the repair of scratches in vehicular clear coats which do not damage the underlying paint coat. Stated otherwise, all known methods for repairing scratches in the clear coat require the damage/repair of the paint coat before the clear coat can be repaired.

### SUMMARY OF THE INVENTION

It is, therefore, a primary object of this invention to provide a composition for the repair of scratches in vehicular clear coats.

It is still another object of this invention to provide a composition which is easily applied to a scratch in a vehicle's clear coat and which is capable, due to its physical and chemical properties, of filling the scratch and reinstating the integrity of the vehicle's clear coat.

It is another object of this invention to provide a method for the repair of scratches in vehicular clear coats.

It is yet another object of this invention to provide a method for the repair of scratches in vehicular clear coats which does not damage the underlying paint coat.

The foregoing and other objects are achieved in accordance with the present invention by providing a composition for the repair of scratches in a vehicular clear coat which includes a solvent mixture for dissolving acrylic resins and an acrylic resin mixture which, upon drying, provides a transparent, high gloss clear coat which is scratch resistant and buffs easily without removing too much of the surrounding or existing clear coating. The solvent mixture is formulated to provide a speed of dry of the composition in the range of 2 to 10 minutes, preferably 3 to 5 minutes.

In another aspect of the invention the composition includes a strong surface tension reducer to facilitate filling of the scratches and a plasticizer and coalescent to improve adhesion and film strength.

In yet another aspect of the invention the composition is formulated to provide a relatively viscous, but flowable and easily spreadable, composition having an optimum viscosity in the range of 400-600 cps.

In still another aspect of the invention, the composition comprises the following ingredients in the proportion ranges indicated, in percent by weight of the composition:

| | |
|---|---|
| toluene | 10-18% |
| n-butyl acetate | 10-15% |
| ethyl acetate | 0-5% |
| acetone | 20-25% |
| acrylic resins | 30-50% |
| surface tension reducer | 0-0.5% |
| plasticizer/coalescent | 0-3% |

In yet another aspect of the present invention, there is provided a method of repairing scratches in vehicular clear coats without damaging the underlying paint coat which involves the steps of applying an amount of a repair composition to the scratch at least sufficient to fill the scratch, spreading the composition into and over the scratch until the composition at least fills the scratch, allowing the composition to air dry, sanding the dried composition to create a smooth, continuous surface at the site of the scratch and buffing the sanded surface with a fine polishing compound to establish a high gloss, clear coat surface at the site of the scratch.

### DETAILED DESCRIPTION OF THE INVENTION

The present invention provides a method for removing scratches in the clear coat of vehicles without damaging or involving the underlying paint coat in any way. As a result, there is no need to follow the time consuming, equipment intensive and expensive procedure currently practiced in vehicular body shops today which involves sanding away the scratch, priming the metallic substrate, repairing the paint coat and blending the newly painted surfaces with surrounding surfaces and coating the new paint coat and the remaining areas of the vehicular panel in which the scratch occurred with a new clear coat. Rather, according to the present invention, the scratches in the clear coat can be repaired by a relatively simple method which involves the steps of applying an amount of a repair composition to the scratch which is at least sufficient to fill the scratch, spreading the composition into and over the scratch until the composition at least fills the scratch, allowing the composition to air dry, sanding the dried composition to create a smooth, continuous surface at the site of the scratch and buffing the sanded surface with a fine polishing compound to establish a high gloss, clear coat surface at the site of the scratch.

The repair composition will be described more fully hereinafter. Briefly however, the composition comprises a mixture of acrylic resins in a solvent mixture which is formulated to make the composition easy to apply to scratches, easy to fill into the scratches and quick to dry, which allows buffing of the clear coat soon after application. The resin composition is desirably relatively viscous, but flowable and easily spreadable, having an optimum viscosity in the range of 400-600 cps. In one embodiment of the invention the resin composition is desirably applied to the scratch as a cylindrical elongate bead, similar to toothpaste being squeezed out of a tube, using a plunger-type syringe. It will be appreciated that other ways of applying viscous materials to a surface can be used, which are well known in the art. The resin composition is spread over and into the scratch using, for example, a finger, squeegee (such as a rubber or leather squeegee), spatula, trowel, or the like, until the composition fills and covers the scratch. It is desirable that at least sufficient resin composition be applied to fill the scratch although, invariably, some amount greater than the minimum needed will generally be applied to be on the safe side and assure that the scratch is filled. Excess resin composition should be removed after the composition is spread and the scratch is filled. Sufficient time should be allowed for the resin composition to completely dry. Depending upon the formulation of the composition and, particularly, depending upon the solvents employed, each different composition formulation will dry in greater or lesser time. It is desirable, from the standpoint of expediting the repair, for the composition to dry in about 2 to 10 minutes, preferably 3 to 5 minutes. When the resin composition is dry it is sanded with a fine sandpaper or the equivalent to create as smooth and continuous a surface as possible wherever resin composition was applied. One simple means of achieving this is to hand sand the composition using 2000 grit sandpaper although, it will be appreciated, other means of sanding and other finenesses/roughnesses may be employed. As a final step, the sanded surface is buffed with a fine grit polishing compound or combination of compounds to re-establish a high gloss, clear coat surface at the site of the scratch. No special equipment need be used, although it is desirable to utilize a commercial buffer and foam polishing pads. It will be appreciated that other equipment and polishing pads, such as pads having a pile of natural wool fibers, can also be used. Polishing compounds of many types are commonly commercially available and, generally, include one or more of aluminum silicate, bentonite clay, calcined alumina, polysiloxanes, glycerine, kaolin clay, mineral oils and spirits, and the like. Examples of satisfactory polishing compounds are 3M™ Perfect-It™ available from 3M Company of St. Paul, Minn. and Norton Liquid Ice® Extra Cut available from Saint-Gorbain Adhesives, Inc. of Worcester, Mass.

Turning to the resin compositions of the present invention which are suitable for use in the method of the present invention, the present invention provides a composition for the repair of scratches in a vehicular clear coat which includes a solvent mixture for dissolving acrylic resins in order to provide a speed of dry of the composition in the range of 2 to 10 minutes, preferably 3 to 5 minutes, and an acrylic resin mixture which, upon drying, provides a transparent, high gloss clear coat which is scratch resistant and buffs easily without removing too much of the surrounding or existing clear coating. In a preferred embodiment, the composition includes a strong surface tension reducer to facilitate filling of the scratches and a plasticizer and coalescent to improve adhesion and film strength. The composition is formulated to provide a relatively viscous, but flowable and easily spreadable, composition having an optimum viscosity in the range of 400-600 cps.

The preferred resin composition for use in accordance with the present invention comprises the following ingredients in the proportion ranges indicated, in percent by weight of the composition:

| | |
|---|---|
| toluene | 10-18% |
| n-butyl acetate | 10-15% |
| ethyl acetate | 0-5% |
| acetone | 20-25% |
| acrylic resins | 30-50% |
| surface tension reducer | 0-0.5% |
| plasticizer/coalescent | 0-3% |

The solvents employed in the resin composition of the present invention are generally considered fast drying solvents in order to achieve the desired 2 to 10 minutes, preferably 3-5 minutes, speed of dry when the resin composition is applied to a scratch. Although the particular solvents listed are most preferred, the invention is not limited thereto. Other solvents for the acrylic resins may include other ketones, esters, ether alcohols, aromatic hydrocarbons, and the like, provided that the solvents completely dissolve the acrylic resins in the composition, provide the desired speed of dry and do not degrade the favorable properties of the composition.

The acrylic resins most useful in the resin composition of the present invention include the methyl methacrylates, butyl methacrylates, ethyl methacrylates, and polymers, copolymers and combinations of these resins. Particularly preferred are acrylic resins selected from Paraloid® resins available from Rohm and Haas and Elvacite® resins available from Lucite International, Inc. In particular, a blend of resins selected from Paraloid® resins having a T_{g} of about 50° C. and Elvacite® resins having a T_{g} of about 59° C. in the weight ratio of about 55%-65% Paraloid® resin to about 35%-45% Elvacite® resin, by weight of total resin, is particularly desirable. The desired resin concentration in the resin composition of the present invention is in the range of about 40-45% by weight of total resin.

In preferred formulations, the resin composition of the present invention also includes a strong surface tension reducer to facilitate filling of the scratches. One such desirable surface tension reducer is a polyether modified polydimethylsiloxane, although other well known surface tension reducers may also be used which are compatible with the acrylic resins of the resin composition and which do not degrade the favorable properties of the composition, such as dry time, viscosity and formation of a clear coat having a relative hardness which is scratch resistant yet which buffs easily. Another optional, but desirable, ingredient is a plasticizer and coalescent to improve adhesion and film strength. One such desirable plasticizer is diisodecyl phthalate, although other well known plasticizers, such as dibutyl phthalate or other phthalates, compatible with the acrylic resins of the resin composition and which do not degrade the favorable properties of the composition may also be used.

The preparation of the resin compositions of the present invention is simple and straightforward. A skilled polymer chemist knowledgeable in the production of lacquers and paints will be able to prepare them without difficulty. In one example, a solution of Paraloid® B-66 resin, which is a polymethyl butyl methacrylate, an Elvacite® low molecular weight methyl methacrylate/n-butyl methacrylate copolymer, the solvents set forth in the table set forth below, diisodecyl phthalate and polyether modified polydimethylsiloxane was made on a Hockmeyer or Cowles disperser, in the following proportions in percent by weight of the composition:

| | |
|---|---|
| toluene | 15.7% |
| n-butyl acetate | 12.4% |
| ethyl acetate | 3.5% |
| acetone | 22.8% |
| acrylic resins | 43.2% |
| polyether modified polydimethylsiloxane | 0.2% |
| diisodecyl phthalate | 2.2% |

Desirably, the acrylic resins comprise a blend of Paraloid® and Elvacite® resins in a blend of 55%-65% Paraloid® and 35%-45% Elvacite® by weight of total resin and, more specifically, in a particularly preferred embodiment of 27.2% Paraloid® and 16.0% Elvacite® by weight of the composition.

The resulting resin composition had a resin concentration of 43.2% by weight of total resin and a viscosity in the range of 400-600 cps. When applied to a metal substrate the composition dried in about 3 minutes. This composition was applied to an automobile body having a scratch in its clear coat which did not extend into the underlying paint coat. A plunger-type syringe was used to extrude a cylindrical bead onto the scratch and a squeegee was used to spread the resin composition into the scratch. As much as possible of the excess resin composition was removed. The composition was allowed to air dry for five minutes, although it appeared to be completely dry after about three minutes. Thereafter, 2000 grit sandpaper was used to hand sand the resin composition to create a smooth and continuous surface containing no apparent scratches or nicks. The sanded area was then buffed using a commercial buffing machine, a foam buffing and polishing pad and a fine grit polishing compound until a high gloss, clear coat covered the surface at the site of the scratch. Upon close examination, the scratch was no longer visible.

While the present invention has been described in terms of specific embodiments thereof, it will be understood that no limitations are intended to the details of formulation or process other than as defined in the appended claims.

1. A method for repairing a scratch in the clear top coat overlying a pigmented base coat on a metallic substrate without damaging the pigmented base coat, comprising the steps of:
applying an amount of a repair composition to the scratch at least sufficient to fill the scratch;
spreading the repair composition into and over the scratch until the repair composition at least fills the scratch;
allowing the repair composition to air dry;
sanding the dried repair composition to create a smooth, continuous surface at the site of the scratch; and
buffing the sanded surface with a fine polishing compound to establish a high gloss, clear coat surface at the site of the scratch.

2. A method, as claimed in claim 1, including the step of removing excess repair composition prior to allowing the repair composition to air dry.

3. A method, as claimed in claim 1, wherein said resin composition has a viscosity in the range of 400-600 cps and is flowable and spreadable prior to drying.

4. A method, as claimed in claim 3, wherein said resin composition has a dry time of about 2 to 10 minutes.

5. A method, as claimed in claim 4, wherein said resin composition includes one or more acrylic resins which, upon drying, provide a transparent, high gloss clear coat which is scratch resistant and buffs easily without removing too much of the surrounding clear coat.

6. A method, as claimed in claim 5, wherein said resin composition includes one or more acrylic resins selected from the group consisting of methyl methacrylates, ethyl methacrylates, butyl methacrylates, and polymers, copolymers and combinations thereof.

7. A method, as claimed in 6, wherein said resin composition includes acrylic resins selected from polybutyl methyl methacrylate, methyl methacrylate/n-butyl methacrylate copolymer and mixtures thereof.

8. A method, as claimed in claim 5, wherein said resin composition includes one or more acrylic resins selected from the group consisting of acrylic resins having a T_{g} of about 50° C., acrylic resins having a T_{g} of about 59° C., and mixtures thereof.

9. A method, as claimed in claim 8, wherein said resin composition includes a blend of resins consisting essentially of 55%-65% by weight of total resin of acrylic resins having a T_{g} of about 50° C. and 35%-45% by weight of total resin of acrylic resins having a T_{g} of about 59° C.

10. A method, as claimed in claim 9, wherein said resin composition includes one or more acrylic resins selected from the group consisting of methyl methacrylates, ethyl methacrylates, butyl methacrylates, and polymers, copolymers and combinations thereof.

11. A method, as claimed in 9, wherein said resin composition includes a blend of polybutyl methyl methacrylate and methyl methacrylate/n-butyl methacrylate copolymer.

12. A method, as claimed in claim 5, wherein said resin composition includes a surface tension reducer to facilitate filling of the scratch.

13. A method, as claimed in claim 5, wherein said resin composition includes a plasticizer and coalescent to improve adhesion and film strength.

14. A method, as claimed in claim 5, wherein said resin composition consists essentially of the following ingredients in percent by weight of said composition:

| | |
|---|---|
| toluene | 10-18% |
| n-butyl acetate | 10-15% |
| ethyl acetate | 0-5% |
| acetone | 20-25% |
| acrylic resins | 30-50% |
| surface tension reducer | 0-0.5% |
| plasticizer/coalescent | 0-3%. |

15. A method, as claimed in claim 14, wherein said resin composition consists essentially of the following ingredients in percent by weight of said composition:

| | |
|---|---|
| toluene | 15.7% |
| n-butyl acetate | 12.4% |
| ethyl acetate | 3.5% |
| acetone | 22.8% |
| acrylic resins | 43.2% |
| polyether modified polydimethylsiloxane | 0.2% |
| diisodecyl phthalate | 2.2%, |

wherein said resin composition includes one or more acrylic resins selected from the group consisting of methyl methacrylates, ethyl methacrylates, butyl methacrylates, and polymers, copolymers and combinations thereof and comprises a blend of resins consisting essentially of 55%-65% by weight of total resin of acrylic resins having a T_{g} of about 50° C. and 35%-45% by weight of total resin of acrylic resins having a T_{g} of about 59° C.

16. A method, as claimed in claim 15, wherein said resin composition includes a blend of polybutyl methyl methacrylate and methyl methacrylate/n-butyl methacrylate copolymer.

17. A resin composition for repairing a scratch in the clear top coat overlying a pigmented base coat on a metallic substrate including one or more acrylic resins selected from the group consisting of methyl methacrylates, ethyl methacrylates, butyl methacrylates, and polymers, copolymers and combinations thereof and one or more solvents for the acrylic resin, said resin composition, upon drying, providing a transparent, high gloss clear coat which is scratch resistant and buffs easily without removing too much of the surrounding clear coat, said resin composition having a dry time of about 2 to 10 minutes.

18. A resin composition, as claimed in claim 17, wherein said acrylic resins are selected from the group consisting of acrylic resins having a T_{g} of about 50° C., acrylic resins having a T_{g} of about 59° C., and mixtures thereof.

19. A resin composition, as claimed in claim 18, wherein said acrylic resins comprise a blend of resins consisting essentially of 55%-65% by weight of total resin of acrylic resins having a T_{g} of about 50° C. and 35%-45% by weight of total resin of acrylic resins having a T_{g} of about 59° C.

20. A resin composition, as claimed in claim 17, wherein said acrylic resins are selected from polybutyl methyl methacrylate, methyl methacrylate/n-butyl methacrylate copolymer and mixtures thereof.

21. A resin composition, as claimed in claim 17, consisting essentially of the following ingredients in percent by weight of said composition:

| | |
|---|---|
| toluene | 10-18% |
| n-butyl acetate | 10-15% |
| ethyl acetate | 0-5% |
| acetone | 20-25% |
| acrylic resins | 30-50% |
| surface tension reducer | 0-0.5% |
| plasticizer/coalescent | 0-3%. |

22. A resin composition, as claimed in claim 21, consisting essentially of the following ingredients in percent by weight of said composition:

| | |
|---|---|
| toluene | 15.7% |
| n-butyl acetate | 12.4% |
| ethyl acetate | 3.5% |
| acetone | 22.8% |
| acrylic resins | 43.2% |
| polyether modified polydimethylsiloxane | 0.2% |
| diisodecyl phthalate | 2.2%, |

wherein said resin composition includes one or more acrylic resins selected from the group consisting of methyl methacrylates, ethyl methacrylates, butyl methacrylates, and polymers, copolymers and combinations thereof and comprises a blend of resins consisting essentially of 55%-65% by weight of total resin of acrylic resins having a T_{g} of about 50° C. and 35%-45% by weight of total resin of acrylic resins having a T_{g} of about 59° C.

23. A method, as claimed in claim 22, wherein said resin composition includes a blend of polybutyl methyl methacrylate and methyl methacrylate/n-butyl methacrylate copolymer.
